(19) United States
(12) Patent Application Publication
(10) Pub. No.: US 2007/0259176 A1
(43) Pub. Date: Nov. 8, 2007

(54) Metal Oxide Sol, Layer Produced Therewith and Shaped Article

(75) Inventors: Yi Deng, Hanau (DE); Monika Oswald, Hanau (DE); Klaus Deller, Hainburg (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: DEGUSSA AG, Duesseldorf (DE)

(21) Appl. No.: 11/629,914

(22) PCT Filed: Jun. 10, 2005
(86) PCT No.: PCT/EP05/06244

§ 371 Date: Dec. 18, 2006

(30) Foreign Application Priority Data
Jun. 22, 2004 (DE) 10 2004 030 093.3

(51) Int. Cl. C01B 13/32

(52) U.S. Cl. 428/357; 427/213.31

(57) ABSTRACT

Process for the preparation of a binder-free metal oxide sol, comprising the steps: a) initial introduction into a vessel of a metal oxide dispersion, wherein the metal oxide powder in the dispersion has an average, number-related aggregate diameter of less than 200 nm, and b1) addition of a metal alcoholate M(OR)ₓ, and optionally of a hydrolysis catalyst, or b2) addition of a starting sol which is obtained by hydrolysis of a metal alcoholate M(OR)ₓ with a hydrolysis catalyst, and the weight-related ratio of metal oxide from the hydrolysis to metal oxide in the dispersion is 0.01 to 1. Metal oxide sol obtainable by this process. Coated substrate which can be produced by means of the metal oxide sol, and shaped article.

The invention relates to a metal oxide sol which comprises a metal oxide powder and the hydrolysis product of a metal alcoholate, and to a coated substrate produced therewith and a shaped article.

It is known to produce metal oxide layers, in particular silicon dioxide layers, by the sol-gel process. In this process, silicon alkoxides are partly or completely hydrolysed by addition of water in the presence of a catalyst. The sols thereby obtained are employed for coating, for example by means of dip-coating or spin-coating.

The preparation process of sols is complex. As a rule, it comprises preparation of a sol by hydrolysis of a metal alkoxide and a subsequent gelling step, which can take some seconds to some days, depending on the chemical composition of the sol. If the gelling does not proceed too rapidly, it is possible to apply a layer from the sol on a substrate. The layers produced in this way are thin, as a rule not more than a few hundred nanometres.

Several coating operations are necessary for production of thicker layers. Layers produced in this manner often tend towards cracking and irregular layer thicknesses during subsequent drying and sintering steps. It remains to be stated that such a sol obtained by hydrolysis of metal alcoholates is a complex “living” system, the behaviour of which depends critically on the temperature, the moisture, the content of alcohol and other parameters and is difficult to control and to reproduce.

WO 00/14013 describes a process in which a very finely divided, pyrogenically prepared silicon dioxide powder is added to a sol prepared as described above. It is thus possible to increase the degree of filler content of the sol and to achieve layers of several micrometres thickness in a single coating operation. The introduction of the finely divided, pyrogenically prepared silicon dioxide powder presents problems in this process.

Pyrogenically prepared metal oxide powders are generally understood as meaning those which are obtained from a metal oxide precursor by a flame hydrolysis or flame oxidation in an oxyhydrogen flame. In this process, approximately spherical primary particles are initially formed, these sintering together to aggregates during the reaction. The aggregates can then accumulate into agglomerates. In contrast to the agglomerates, which as a rule can be separated into the aggregates relatively easily by introduction of energy, the aggregates are broken down further, if at all, only by intensive introduction of energy.

If such a pyrogenically prepared metal oxide powder is now introduced into a sol by means of stirrer energy, there is the risk of precipitous gelling. On the other hand, it is difficult for the powder introduced to be distributed uniformly in the sol, so that non-uniform layers can result.

WO 01/53225 describes a process in which a silicon alkoxide is added to a paste of silicon dioxide particles in water. The sol formed is gelled and subsequently sintered in order to obtain a silica vitreous body. It has been found that shaped articles produced in this manner have inhomogeneities. It is not disclosed in the document how the silicon dioxide particles are incorporated into the water and what properties the resulting paste has. In a preferred embodiment, the silicon dioxide particles in the sol have an average particle size of 1.75 μm.

It is furthermore prior art to improve the application of a dispersion by addition of binders. A disadvantage in this procedure is that as a rule the binder can be removed completely in a sintering step only with difficulty. The consequence of this can be discolorations and cracks.

The object of the invention is to provide a sol which is suitable for application of layers and which avoids the disadvantages of the sols of the prior art. In particular, it should be suitable for the production of thick, crack-free, vitreous or ceramic layers. It should furthermore be suitable for the production of shaped articles which are free from cracks and inhomogeneities.

The invention provides a process for the preparation of a binder-free metal oxide sol, comprising the steps:
a) initial introduction into a vessel of a metal oxide dispersion which has a content of metal oxide, based on the total amount of the dispersion, of 5 to 80 wt. % and which contains as the liquid phase water or a mixture of water and a water-miscible organic solvent,
   wherein
   the metal oxide powder is SiO₂, Al₂O₃, TiO₂, CeO₂, ZrO₂, In₂O₃, SnO, SbO or a mixed oxide of the metals mentioned, and
   the metal oxide powder in the dispersion has an average, number-related aggregate diameter d₅₀ of less than 200 nm,
b1) addition to the metal oxide dispersion, with introduction of energy, of a metal alcoholate of the general formula M(OR)ₓ, which results in the corresponding metal oxide and an alcohol ROH in the dispersion by hydrolysis, and optionally a hydrolysis catalyst, or
b2) addition, with introduction of energy, of a starting sol, which is obtained by hydrolysis of a metal alcoholate of the general formula M(OR)ₓ in water or a mixture of water and a water-miscible organic solvent and a hydrolysis catalyst,
   wherein
   M=Si, Al, Ti, Ce, Zr, In, Sn or Sb, R═C₁-C₆-alkyl and x is the valency of the metal and
   the weight-related ratio of metal oxide from the hydrolysis to metal oxide in the dispersion is 0.01 to 1.

The metal oxide dispersion contains as the liquid phase water or a mixture of water and a water-miscible organic solvent. In addition, small amounts of substances having an acidic action, substances having a basic action and/or salts, in each case in dissolved form, can also be present.

In the process according to the invention, an alcohol ROH is formed by the hydrolysis of the alkoxide. This alcohol can optionally be removed completely or partly from the sol, together with an organic solvent, which can be contained in the liquid phase of the dispersion. However, it has been found that it may be advantageous, depending on the nature of the substrate to be coated, to leave the alcohol ROH completely or predominantly in the sol.

In the process according to the invention, it is furthermore necessary for the weight-related ratio of metal oxide from the hydrolysis to metal oxide in the dispersion to be in a range from 0.01 to 1. At values below 0.01 inhomogeneities are often found in the coating, and at values above 1 cracks are often found in the coating. The best results are obtained if the weight-related ratio of metal oxide from the hydrolysis to metal oxide in the dispersion is in a range from 0.1 to 0.5.

In the process according to the invention, it is furthermore necessary for the metal oxide powder in the dispersion to have an average, number-related aggregate diameter of less than 200 nm. Coarser aggregate diameters lead to non-uniform coatings.

The metal oxide powder in the dispersion advantageously has an average, number-related aggregate diameter of less than 100 nm. Dispersions having such small particles can be prepared by specific dispersing techniques. Suitable dispersing devices can be, for example, rotor-stator machines or planetary kneaders, where high-energy mills may be particularly preferred specifically for aggregate diameters of less than 100 nm. In these devices, two predispersed dispersion streams under a high pressure are let down via a nozzle. The two dispersion jets impinge exactly on one another and the particles grind themselves. In another embodiment, the predispersion is likewise placed under a high pressure, but the collision of the particles takes place against armoured wall regions. The operation can be repeated as often as desired, in order to obtain smaller particle sizes.

While for the preparation of the metal oxide dispersion introduction of a high amount of energy is necessary in order to achieve the necessary particle fineness of less than 200 nm, in the generation of the metal oxide sol, that is to say during the addition of the metal alcoholate or of the starting sol to the dispersion, introduction of only a small amount of energy is necessary. It has been found that introduction of too high an amount of energy during this reaction step has an adverse effect on the quality of a coating. Slow stirring of the metal alcoholate or starting sol into the dispersion is therefore as a rule sufficient.

The choice of the hydrolysis catalyst for the formation of the starting sol or the metal oxide sol according to the invention primarily depends on the metal alcoholate to be hydrolysed. All catalysts known to the expert are suitable. If the hydrolysis of the alcoholate is carried out in the metal oxide dispersion itself (route b1), as a rule the acid present in the dispersions, which are usually rendered acidic, is sufficient as the hydrolysis catalyst.

The choice of organic solvent in the sol according to the invention is not critical, as long as it is miscible with water. The dispersion according to the invention can preferably contain methanol, ethanol, n-propanol, iso-propanol, n-butanol, glycol, tert-butanol, 2-propanone, 2-butanone, diethyl ether, tert-butyl methyl ether, tetrahydrofuran and/or ethyl acetate.

In a preferred embodiment, the content of metal oxide powder of the dispersion employed in the process according to the invention is 20 to 60 wt. %, based on the total amount of dispersion.

The origin of the metal oxide powder employed is not decisive for the process according to the invention. However, it has been found that pyrogenically prepared metal oxide powders can advantageously be employed. The preparation of silicon dioxide by flame hydrolysis of silicon tetrachloride may be mentioned by way of example. Mixed oxides can also be obtained in pyrogenic processes by joint flame hydrolysis or flame oxidation. In this context, mixed oxides also include doped metal oxides, such as, for example, silicon dioxide doped with silver.

Pyrogenic metal oxide powders having a BET surface area of 30 to 200 m²/g can advantageously be employed.

All alcoholates which are hydrolysed to a metal oxide sol under the reaction conditions can in principle be employed as metal alcoholates. Tetramethoxysilane, tetraethoxysilane, aluminium iso-propylate, aluminium tri-sec-butylate, tetraethyl orthotitanate, titanium iso-propylate or zirconium n-propylate can preferably be employed.

The invention also provides a metal oxide sol which is obtained by the process according to the invention.

The invention furthermore provides a substrate coated with the metal oxide sol according to the invention.

The process for the production of the coated substrate comprises application of the metal oxide sol to the substrate by dip-coating, brushing, spraying or knife-coating, with subsequent drying of the layer adhering to the substrate and then sintering.

Suitable substrates can be metal or alloy substrates, materials having very low coefficients of thermal expansion (ultra-low expansion materials), borosilicate glasses, silica glasses, glass ceramic or silicon wafers.

The invention furthermore provides a shaped article produced with the metal oxide sol according to the invention.

The process for the production of the shaped article comprises casting the metal oxide sol according to the invention into a mould, preferably of hydrophobic material, subsequently drying it at temperatures below 100° C., optionally after-drying the product at temperatures of 60° C. to 120° C. after removal from the mould and subsequently sintering it.

### EXAMPLES

### Example A-1

100 g tetraethoxysilane (TEOS) are added, while stirring, to 360 g of a 30 percent strength dispersion of Aerosil® OX50, Degussa AG, in water, the pH of which is brought to pH 2 with hydrochloric acid, and the mixture is then stirred further for another 48 minutes.

The AEROSIL® OX50 particles in the dispersion have an average, number-related aggregate diameter of 121 nm.

A glass pane is coated with this metal oxide sol by means of dip-coating and the layer is dried at temperatures of less than 100° C. A crack-free, homogeneous green layer having a substantially uniform layer thickness of 4.2 μm is obtained at a drawing speed of 10 cm/min.

### Example B-1

Starting sol: A mixture of 150 ml water and 100 ml ethanol is brought to a pH of 2 with 1 M hydrochloric acid.

Thereafter, 100 g TEOS are added and the sol is homogenized by stirring on a magnetic stirrer.

Metal oxide dispersion: . . . to 360 g of a 25 percent strength aqueous dispersion of AEROXIDE® TiO₂ P25, Degussa AG, which is adjusted to a pH of 2 by addition of 1 M hydrochloric acid. The average, number-related aggregate diameter of the TiO₂ particles in the dispersion is 98 nm.

Metal oxide sol: 150 ml of the TiO₂ dispersion are mixed with 100 ml of starting sol, while stirring, and the mixture is then homogenized for 30 minutes by stirring on a magnetic stirrer.

Layer: A glass pane is coated with this metal oxide sol by means of dip-coating and the layer is dried at temperatures of less than 100° C. A crack-free, homogeneous green layer having a substantially uniform layer thickness of 2.2 μm is obtained at a drawing speed of 10 cm/min.

### Example B-2

Starting sol: Preparation analogous to Example 2.

Metal oxide dispersion: AERODISP® W 630, Degussa AG, an aqueous dispersion of AEROXIDE® Alu C, Degussa, having an aluminium oxide content of 30 wt. % and a pH of 4.7. The average, number-related aggregate diameter of the Al₂O₃ particles in the dispersion is 87 nm.

Metal oxide sol: Preparation analogous to Example B-1.

Layer: Dip-coating and drying conditions analogous to Example B-1.

Crack-free layer thickness obtained for the green layer: 2.2 μm

1. Process for the preparation of a binder-free metal oxide sol comprising the steps:
a) initial introduction into a vessel of a metal oxide dispersion which has a content of metal oxide, based on the total amount of the dispersion, of 5 to 80 wt. % and which contains as the liquid phase water or a mixture of water and a water-miscible organic solvent,
wherein
the metal oxide powder is SiO₂, Al₂O₃, TiO₂, CeO₂, ZrO₂, In₂O₃, SnO, SbO or a mixed oxide of the metals mentioned, and
the metal oxide powder in the dispersion has an average, number-related aggregate diameter of less than 200 nm,
b1) addition to the metal oxide dispersion, with introduction of energy, of a metal alcoholate of the general formula M(OR)ₓ, which results in the corresponding metal oxide and an alcohol ROH in the dispersion by hydrolysis, and optionally a hydrolysis catalyst, or
b2) addition, with introduction of energy, of a starting sol, which is obtained by hydrolysis of a metal alcoholate of the general formula M(OR)ₓ in water or a mixture of water and a water-miscible organic solvent and a hydrolysis catalyst,
wherein M=Si, Al, Ti, Ce, Zr, In, Sn or Sb, R═C₁-C₆-alkyl and x is the valency of the metal and the weight-related ratio of metal oxide from the hydrolysis to metal oxide in the dispersion is 0.01 to 1.

2. Process according to claim 1, wherein the alcohol ROH formed during the hydrolysis is completely or partly removed from the sol, optionally together with the organic solvent.

3. Process according to claim 1 wherein the weight-related ratio of metal oxide from the hydrolysis to metal oxide in the dispersion is 0.1 to 0.5.

4. Process according to claim 1 wherein the metal oxide powder in the dispersion has an average, number-related aggregate diameter of less than 100 nm.

5. Process according to claim 1 wherein the dispersion has a content of metal oxide powder of 20-60 wt. %.

6. Process according to claim 1 wherein the metal oxide powder is prepared pyrogenically.

7. Process according to claim 6, wherein the metal oxide powder has a BET surface area of 30 to 200 m²/g.

8. Process according to claim 1 wherein the metal alcoholate is tetramethoxysilane, tetraethoxysilane, aluminium iso-propylate, aluminium tri-sec-butylate, tetraethyl orthotitanate, titanium iso-propylate or zirconium n-propylate.

9. Metal oxide sol, obtainable according to claim 1.

10. A substrate coated with the metal oxide sol according to claim 9.

11. A process for the production of a coated substrate comprising:
applying the metal oxide sol according to claim 9 to the substrate by means of dip-coating, brushing, spraying or knife-coating;
subsequent drying of the layer adhering to the substrates and then
sintering.

12. A shaped article produced with the metal oxide sol according to claim 9.

13. A process for the production of a shaped article comprising:
casting the metal oxide sol according to claim 9 is cast into a mould;
drying at temperatures below 100° C.;
removing the shaped article from the mould;
optionally after-drying at temperatures of 60° C. to 120° C.; and subsequently
sintering.
